(19) United States
(12) Patent Application Publication
(10) Pub. No.: US 2024/0418329 A1
(43) Pub. Date: Dec. 19, 2024

(54) FILLABLE 5.56 MAGAZINE CHEMLIGHT

(71) Applicant: Andrew Wright, Brandon, FL (US)

(72) Inventor: Andrew Wright, Brandon, FL (US)

(21) Appl. No.: 18/210,307

(22) Filed: Jun. 15, 2023

(51) Int. Cl. F21K 2/06

(52) U.S. Cl. CPC F21K 2/06

(57) ABSTRACT

A fillable 5.56 magazine chemlight may include a generally cylindrical flexible plastic housing including a primary body transitioning into a shoulder transitioning into a neck, the housing defining a cavity therein. The chemlight may include oxalate ester and a dye disposed within the first cavity. A vessel including comprising hydrogen peroxide may be disposed within the first cavity. The housing may be flexible enough to be bent, thereby breaking the vessel and mixing the oxalate ester, dye, and hydrogen peroxide to create a chemiluminescent fluid.

### TECHNICAL FIELD

The embodiments generally relate to chemical light sticks, such as products containing diphenyl oxalate or oxalate ester and an electron-rich dye.

### BACKGROUND

Standard chemical light sticks (“chemlight” or “chemlights”) are used regularly in military or law enforcement operations to mark safe or cleared areas or rooms, areas to avoid, or to identify boundaries or personnel more mark landing zones.

A chemlight may include a flexible, transparent, or semitransparent plastic housing containing a mixture of oxalate ester and an electron-rich dye along with a glass vessel containing hydrogen peroxide solution. The chemical light stick may be bent to crack open the glass vessel such that the hydrogen peroxide solution and oxalate ester and electron-rich dye mix to form 1,2-dioxetanedione, resulting in chemiluminescence i.e. a glowing fluid within the plastic housing.

Standard chemical light sticks are typically four to six inches long or may come in miniature versions approximately one and a half inches long. Standard chemical lights proportions limit the usability of the lights and the number of chemlights an individual can carry at any given time, particularly when chemlights are being carried, stored, or organized by military or law enforcement personnel.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments described herein provide a chemlight including a housing proportioned to increase the carrying capacity of chemlights as well as providing a convenient, practical storage solution for carrying a large number of chemlights. The chemlights may include a housing constructed and arranged to fit within a standard issue 5.56 mm rifle magazine.

Both the foregoing general description and the following detailed description present embodiments intended to provide an overview or framework for understanding the nature and character of the embodiments disclosed herein. Any accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a cross-sectional view of a chemlight, according to some embodiments;

FIG. 2 illustrates a cross-sectional view of a chemlight, according to some embodiments;

FIG. 3 illustrates a view of a chemlight, according to some embodiments;

FIG. 4 illustrates a view of a plurality of chemlights being loaded into a standard issue 5.56 mm rifle magazine, according to some embodiments; and

FIG. 5 illustrates a view of a plurality of chemlights loaded into a standard issue 5.56 mm rifle magazine, according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used to distinguish one entity or element from another entity or element without necessarily requiring or implying any physical or logical relationship, or order between such entities or elements.

The embodiments described herein provide a chemlight including a housing proportioned to fit within a standard issue 5.56 mm rifle magazine, and in particular, proportioned to fit up to 30 chemlights within a 5.56 mm rifle magazine. The housing may be generally cylindrical and may generally resemble and be proportioned similarly to the casing of 5.56 mm ammunition. The housing may be transparent or semitransparent. The 5.56 mm rifle magazine may be loaded with chemlights in a manner similar to the way ammunition is loaded into a 5.56 mm rifle magazine. Similarly, when a chemlight is removed from the 5.56 mm rifle magazine, another chemlight is forced to the top of the 5.56 mm rifle magazine via an internal spring, making another chemlight readily available. In this way, the disclosed chemlight provides a convenient means for individuals to carry many chemlights in a standard 5.56 mm rifle magazine and standard 5.56 mm rifle magazine pocket without a need to redesign any equipment worn by a military or law enforcement individual.

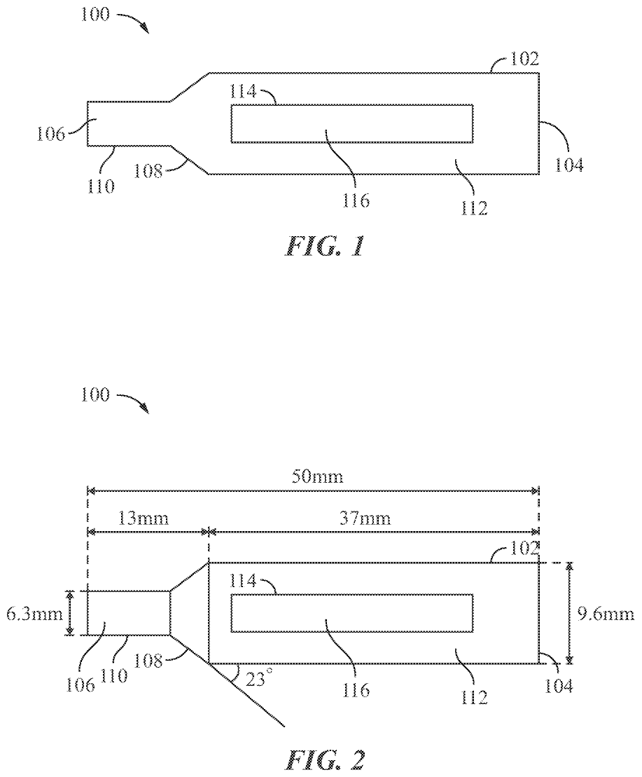

FIG. 1 illustrates a cross-sectional view of a chemlight 100 including a housing 102 including a first end 104 opposite a second end 106, and a primary body 120 transitioning into a shoulder 108 transitioning into a neck 110. The neck 110 may be nearest the second end 106, and the primary body 120 may be nearest the first end 104. The housing 102 may be made of a flexible plastic. The housing 102 may define a cavity 122 in which a first fluid 112, such as diphenyl oxalate or oxalate ester, including a dye may be disposed. A vessel 114 containing a second fluid 114, such as hydrogen peroxide, may also be disposed within the cavity 112. In use, the housing 102 may be bent such that the vessel 114 is broken and the first fluid 112 and second fluid 114 mix.

FIG. 2 illustrates a cross-sectional view of a chemlight 100 including a generally cylindrical housing 102 including a first end 104 opposite a second end 106, and a primary body 120 transitioning into a shoulder 108 transitioning into a neck 110. The housing 102 may be approximately 50 millimeters (mm) long. The first end 104 may be approximately 9.6 mm in diameter. The second end may be approximately 6.3 mm in diameter. The primary body 120 may be approximately 37 mm long. The neck 110 and shoulder 108 may be approximately 13 mm long. The shoulder 108 may be generally conical in shape and may taper from the primary body 120 to the neck 110 at angle A, approximately 23º, relative to the primary body 120.

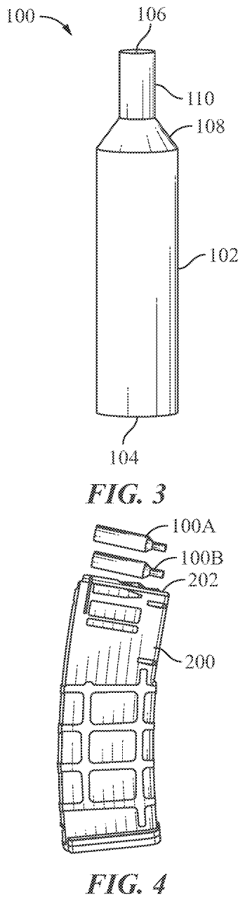

FIG. 3 illustrates a view of a chemlight 100 including a housing 102 including a first end 104 opposite a second end 106, and a primary body 120 transitioning into a shoulder 108 transitioning into a neck 110.

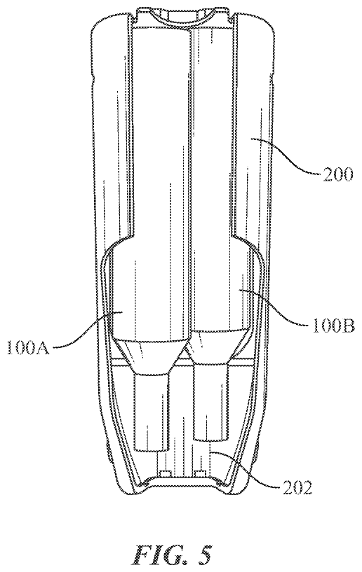

FIG. 4 illustrates a view of a plurality of chemlights 100A, 100B loadable into a standard issue 5.56 mm rifle magazine 200 defining a magazine cavity 202.

FIG. 5 illustrates a view of a plurality of chemlights 100A, 100B loaded into a standard issue 5.56 mm rifle magazine 200 defining a magazine cavity 202. The chemlights 100A, 100B may be loadable within the magazine cavity 202.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a chemlight may include a generally cylindrical housing including a first end opposite a second end, and a primary body transitioning into a shoulder transitioning into a neck, the housing defining a first cavity; a first fluid disposed within the first cavity; a vessel defining a second cavity, the vessel being disposed within the first cavity; and a second fluid disposed within the second cavity.
Variation 2 may include a chemlight as in variation 1, wherein the housing is approximately 50 mm long.
Variation 3 may include a chemlight as in variation 1 or 2, wherein the first end is approximately 9.6 mm in diameter.
Variation 4 may include a chemlight as in any of variations 1 through 3, wherein the second end is approximately 6.3 mm in diameter.
Variation 5 may include a chemlight as in any of variations 1 through 4, wherein the primary body is approximately 37 mm long.
Variation 6 may include a chemlight as in any of variations 1 through 5, wherein the neck and the shoulder are approximately 13 mm long.
Variation 7 may include a chemlight as in any of variations 1 through 6, wherein the shoulder is generally conical in shape and tapers from the primary body to the neck at an angle approximately 23° relative to the primary body.
Variation 8 may include a chemlight as in any of variations 1 through 7, wherein the first fluid includes oxalate ester.
Variation 9 may include a chemlight as in any of variations 1 through 8, wherein the first fluid includes a dye.
Variation 10 may include a chemlight as in any of variations 1 through 9, wherein the first fluid includes oxalate ester and a dye.
Variation 11 may include a chemlight as in any of variations 1 through 10, wherein the second fluid includes hydrogen peroxide.
Variation 12 may include a chemlight as in any of variations 1 through 11, wherein the housing includes a flexible plastic.

According to variation 13, a chemlight may include a generally cylindrical flexible plastic housing including a first end opposite a second end, and a primary body transitioning into a shoulder transitioning into a neck, the housing defining a first cavity; a first fluid including oxalate ester and a dye disposed within the first cavity; a vessel defining a second cavity, the vessel being disposed within the first cavity; and a second fluid including hydrogen peroxide disposed within the second cavity.
Variation 14 may include a chemlight as in variation 13, wherein the housing is approximately 50 mm long.
Variation 15 may include a chemlight as in variation 13 or 14, wherein the first end is approximately 9.6 mm in diameter.
Variation 16 may include a chemlight as in any of variations 13 through 15, wherein the second end is approximately 6.3 mm in diameter.
Variation 17 may include a chemlight as in any of variations 13 through 16, wherein the primary body is approximately 37 mm long.
Variation 18 may include a chemlight as in any of variations 13 through 17, wherein the neck and the shoulder are approximately 13 mm long.
Variation 19 may include a chemlight as in any of variations 13 through 18, wherein the shoulder is generally conical in shape and tapers from the primary body to the neck at an angle approximately 23° relative to the primary body.

According to variation 20, a chemlight may include a generally cylindrical flexible plastic housing including a first end opposite a second end, and a primary body transitioning into a shoulder transitioning into a neck, the housing defining a first cavity; a first fluid including oxalate ester and a dye disposed within the first cavity; a vessel defining a second cavity, the vessel being disposed within the first cavity; and a second fluid including hydrogen peroxide disposed within the second cavity.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A chemlight, comprising:
a generally cylindrical housing comprising a first end opposite a second end, and a primary body transitioning into a shoulder transitioning into a neck, the housing defining a first cavity;
a first fluid disposed within the first cavity;
a vessel defining a second cavity, the vessel being disposed within the first cavity; and a second fluid disposed within the second cavity.

2. The chemlight as in claim 1, wherein the housing is approximately 50 mm long.

3. The chemlight as in claim 1, wherein the first end is approximately 9.6 mm in diameter.

4. The chemlight as in claim 1, wherein the second end is approximately 6.3 mm in diameter.

5. The chemlight as in claim 1, wherein the primary body is approximately 37 mm long.

6. The chemlight as in claim 1, wherein the neck and the shoulder are approximately 13 mm long.

7. The chemlight as in claim 1, wherein the shoulder is generally conical in shape and tapers from the primary body to the neck at an angle approximately 23° relative to the primary body.

8. The chemlight as in claim 1, wherein the first fluid comprises oxalate ester.

9. The chemlight as in claim 1, wherein the first fluid comprises a dye.

10. The chemlight as in claim 1, wherein the first fluid comprises oxalate ester and a dye.

11. The chemlight as in claim 1, wherein the second fluid comprises hydrogen peroxide.

12. The chemlight as in claim 1, wherein the housing comprises a flexible plastic.

13. A chemlight, comprising:
a generally cylindrical flexible plastic housing comprising a first end opposite a second end, and a primary body transitioning into a shoulder transitioning into a neck, the housing defining a first cavity;
a first fluid comprising oxalate ester and a dye disposed within the first cavity;
a vessel defining a second cavity, the vessel being disposed within the first cavity; and a second fluid comprising hydrogen peroxide disposed within the second cavity.

14. The chemlight as in claim 13, wherein the housing is approximately 50 mm long.

15. The chemlight as in claim 13, wherein the first end is approximately 9.6 mm in diameter.

16. The chemlight as in claim 13, wherein the second end is approximately 6.3 mm in diameter.

17. The chemlight as in claim 13, wherein the primary body is approximately 37 mm long.

18. The chemlight as in claim 13, wherein the neck and the shoulder are approximately 13 mm long.

19. The chemlight as in claim 13, wherein the shoulder is generally conical in shape and tapers from the primary body to the neck at an angle approximately 23° relative to the primary body.

20. A chemlight, comprising:
a generally cylindrical flexible plastic housing comprising a first end opposite a second end, and a primary body transitioning into a shoulder transitioning into a neck, the housing defining a first cavity;
a first fluid comprising oxalate ester and a dye disposed within the first cavity;
a vessel defining a second cavity, the vessel being disposed within the first cavity; and a second fluid comprising hydrogen peroxide disposed within the second cavity.
